(19) United States
(12) Patent Application Publication
(10) Pub. No.: US 2025/0316922 A1
(43) Pub. Date: Oct. 9, 2025

(54) ELECTRIC CONNECTOR AND PAIR OF ELECTRIC CONNECTORS

(71) Applicant: Nippon Tanshi Co., Ltd., Hiratsuka-shi, Kanagawa (JP)

(72) Inventors: Masayuki UCHIUMI, Kanagawa (JP); Wataru HASEGAWA, Kanagawa (JP)

(21) Appl. No.: 18/715,437

(22) PCT Filed: Nov. 24, 2022
(86) PCT No.: PCT/JP2022/043281

§ 371 Date: Nov. 5, 2024

(30) Foreign Application Priority Data
Dec. 3, 2021 (JP) 2021-197248

(51) Int. Cl. H01R 13/436; H01R 12/72

(52) U.S. Cl. CPC H01R 13/4361; H01R 12/722

(57) ABSTRACT

An electric connector includes: a plurality of metal terminals; a housing including a plurality of terminal housing chambers, and a retainer insertion hole extending in a lateral direction perpendicular to a front-and-rear direction that corresponds to an insertion direction of the plurality of metal terminals; and a retainer holding the plurality of metal terminals inserted into the plurality of terminal housing chambers, wherein the plurality of terminal housing chambers constitutes each of first and second terminal housing chamber groups, the housing includes a partition wall arranged between the first and second terminal housing chamber groups, the partition wall is provided with a retainer opening, and a locking portion configured to lock a locked portion of the retainer is formed in the retainer opening.

### TECHNICAL FIELD

The present invention relates to an electric connector including a retainer that holds a plurality of metal terminals housed in a housing, and to a pair of electric connectors including the electric connector.

### BACKGROUND ART

Conventionally, a widespread electric connector includes a retainer that locks a plurality of metal terminals respectively inserted into terminal housing chambers of a housing and thereby prevents the metal terminals from being removed from the housing (see Patent Document 1). Such a retainer is inserted into a retainer insertion hole opened on a sidewall forming an outer shell of the housing. However, if an external force acts on the retainer in a direction opposite to an insertion direction of the retainer, the retainer may be detached from the retainer insertion hole.

To prevent a retainer from being detached from a housing, for example, an electric connector is developed (see Patent Document 2). According to this electric connector, a locked protrusion formed on a flexible arm of a retainer is locked by an outer wall (i.e., a sidewall) that defines an opening of a retainer insertion hole of a housing. Further, for example, another electric connector is developed (see Patent Document 3). According to this electric connector, a locked protrusion formed on a retainer is locked by a sidewall that partitions a plurality of cavities (i.e., terminal housing chambers) of a housing.

### PRIOR ART DOCUMENT(S)

### Patent Document(s)

Patent Document 1: JPH3-097875U

Patent Document 2: JPH11-16625A

Patent Document 3: JP2015-133216A

### SUMMARY OF THE INVENTION

### Task to be Accomplished by the Invention

In the conventional technique described in Patent Documents 2 and 3 described above, the locked protrusion formed on the retainer is locked by an outer wall or an inner wall (i.e., sidewalls of terminal housing chambers in which metal terminals are respectively housed) of the housing arranged perpendicular to an insertion direction of the retainer. Accordingly, the strength with which the housing holds the retainer (i.e., the ability to prevent the retainer from being detached from the housing) depends on the rigidity and strength (i.e., the thickness of walls, the shape, and the like) of a member defining the outer wall or the inner wall of the housing.

Accordingly, in the conventional technique described above, it may be difficult to stably secure the strength with which the housing holds the retainer if the change in the thickness and the like of the outer wall or the inner wall is restricted due to the design of the housing.

In view of the above background, an object of the present invention is to provide an electric connector that can stably secure the strength with which a housing holds a retainer, and a pair of electric connectors including the electric connector.

### Means to Accomplish the Task

To achieve such an object, the first aspect of the present invention provides an electric connector (5), comprising: a plurality of metal terminals (31); a housing (33) provided with a plurality of terminal housing chambers (47) into which the plurality of metal terminals is inserted respectively, and a retainer insertion hole (51) extending in a lateral direction perpendicular to a front-and-rear direction that corresponds to an insertion direction of the plurality of metal terminals; and a retainer (35) inserted into the retainer insertion hole and thereby holding the plurality of metal terminals inserted into the plurality of terminal housing chambers, wherein the plurality of terminal housing chambers is aligned along the lateral direction and thereby constituting each of a first terminal housing chamber group (101) and a second terminal housing chamber group (102), the first terminal housing chamber group and the second terminal housing chamber group are spaced from each other in an up-and-down direction that is perpendicular to each of the front-and-rear direction and the lateral direction, the housing includes a partition wall (48) arranged between the first terminal housing chamber group and the second terminal housing chamber group, the partition wall is provided with a retainer opening (52) that defines a portion of the retainer insertion hole, the retainer includes a locked portion (57) locked by the housing in a state where the retainer is inserted into the retainer insertion hole, and a locking portion (55) configured to lock the locked portion of the retainer is formed in the retainer opening.

According to this aspect, the locking portion configured to lock the locked portion of the retainer is formed in the retainer opening formed in the partition wall arranged between the first terminal housing chamber group and the second terminal housing chamber group. Accordingly, it is possible to stably secure the strength with which the housing holds the retainer.

In the second aspect according to the first aspect, preferably, the locked portion of the retainer is a protrusion (57) that protrudes to a front or rear of the retainer, the retainer includes an insertion side portion (71) provided with the protrusion, and a base portion (73) formed continuously with the insertion side portion, and a front-and-rear dimension of the insertion side portion including the protrusion is equal to or less than a front-and-rear dimension of the base portion.

According to this aspect, even if the protrusion is provided as the locked portion of the retainer, it is possible for the base portion to secure the front-and-rear dimension required for the housing to stably hold the retainer while suppressing an increase in the front-and-rear dimension (i.e., the dimension in the insertion direction of the metal terminals) of the retainer.

In the third aspect according to the first or second aspect, preferably, the housing includes an upper wall (41) and a lower wall (42) that form an outer shell thereof, the housing includes a plurality of inner walls (49) arranged at a prescribed interval in the lateral direction, and each of the plurality of inner walls connects the upper wall and the lower wall in the up-and-down direction via the partition wall, the plurality of inner walls defines left and right sidewalls of each of the plurality of terminal housing chambers, and each of the plurality of inner walls is provided with a notch (59A, 59B) defining a portion of the retainer insertion hole, and the notch (59A) of an inner wall among the plurality of inner walls corresponding to the insertion side portion of the retainer has a smaller front-and-rear dimension than the notch (59B) of another inner wall among the plurality of inner walls corresponding to the base portion of the retainer.

According to this aspect, the inner walls provided with notches having different front-and-rear dimensions are arranged to correspond to the insertion side portion and the base portion. Accordingly, it is possible to stably hold each of the insertion side portion of the retainer with a smaller front-and-rear dimension and the base portion of the retainer with a larger front-and-rear dimension.

In the fourth aspect according to the second or third aspect, the insertion side portion of the retainer is provided with a long hole (87) arranged inside the protrusion and penetrating through the insertion side portion in the up-and-down direction.

According to this aspect, a portion between the protrusion and the long hole of the retainer can be easily deformed. Accordingly, the protrusion is easily locked by the locking portion of the housing.

In the fifth aspect according to the fourth aspect, the retainer includes a cover piece (88) arranged to cover at least one opening of the long hole in a penetration direction thereof.

According to this aspect, it is possible to prevent an unintended electrical connection (i.e., a short circuit) via the long hole from occurring between a metal terminal arranged near the long hole and inserted into the terminal housing chamber in the first terminal housing chamber group and another metal terminal arranged near the long hole and inserted into the terminal housing chamber in the second terminal housing chamber group.

In the sixth aspect according to the fourth or fifth aspect, an elastic deformation portion (89) configured to deform elastically when the protrusion is locked by the locking portion is formed between the protrusion and the long hole of the retainer, and an up-and-down dimension of the elastic deformation portion is smaller than a maximum value of an up-and-down dimension of a whole of the insertion side portion.

According to this aspect, the up-and-down dimension of the elastic deformation portion is smaller than the maximum value of the up-and-down dimension of the whole of the insertion side portion. Accordingly, it is possible to prevent the deformation of the elastic deformation portion between the protrusion and the long hole of the retainer from being inhibited while securing the rigidity of the insertion side portion.

In the seventh aspect according to any one of the first to sixth aspects, the metal terminal is a female metal terminal (31) that is connectable to a male metal terminal, and the housing is a female housing (33) that is connectable to a male housing that holds the male metal terminal.

According to this aspect, it is possible to easily secure a structure for engaging the retainer and the metal terminal using the female metal terminal. Accordingly, the structure of the electric connector including the retainer is simplified.

To achieve such an object, the eighth aspect of the present invention provides a pair of electric connectors (1) comprising the electric connector according to any one of the first to seventh aspects, and another electric connector (3) that is connectable to the electric connector (5).

According to this aspect, in the electric connector that constitutes the pair of electric connectors, the locking portion configured to lock the locked portion of the retainer is formed in the retainer opening formed in the partition wall arranged between the first terminal housing chamber group and the second terminal housing chamber group. Accordingly, it is possible to stably secure the strength with which the housing holds the retainer.

### Effect of the Invention

Thus, according to the above aspects, it is possible to stably secure the strength with which a housing holds a retainer.

### BRIEF DESCRIPTION OF THE DRAWING(S)

FIG. 1 is a perspective view of a pair of electric connectors 1;

FIG. 2 is an exploded perspective view of a female connector 5 according to an embodiment;

FIG. 3 is a front view of a female housing 33;

FIG. 4 is a left side view of the female housing 33;

FIG. 5 shows (A) a perspective view on an upper surface side of a retainer 35, and (B) a perspective view on a lower surface side of the retainer 35;

FIG. 6 is a cross-sectional view of the retainer 35 along a line VI-VI shown in (A) of FIG. 5;

FIG. 7 is an explanatory diagram showing an operation for mounting the retainer 35 on the female housing 33 (the female housing 33 corresponds to a cross section along a line VII-VII in FIG. 3);

FIG. 8 is an explanatory diagram showing the operation for mounting the retainer 35 on the female housing 33 (the female housing 33 corresponds to a cross section along a line VIII-VIII in FIG. 3);

FIG. 9 is an explanatory diagram showing a state where female terminals 31 are held by the retainer 35 (a cross-sectional view along a line IX-IX in FIG. 3); and

FIG. 10 is an explanatory diagram showing a state where the female terminals 31 are held by the retainer 35 (a cross-sectional view along a line X-X in FIG. 3).

### MODE(S) FOR CARRYING OUT THE INVENTION

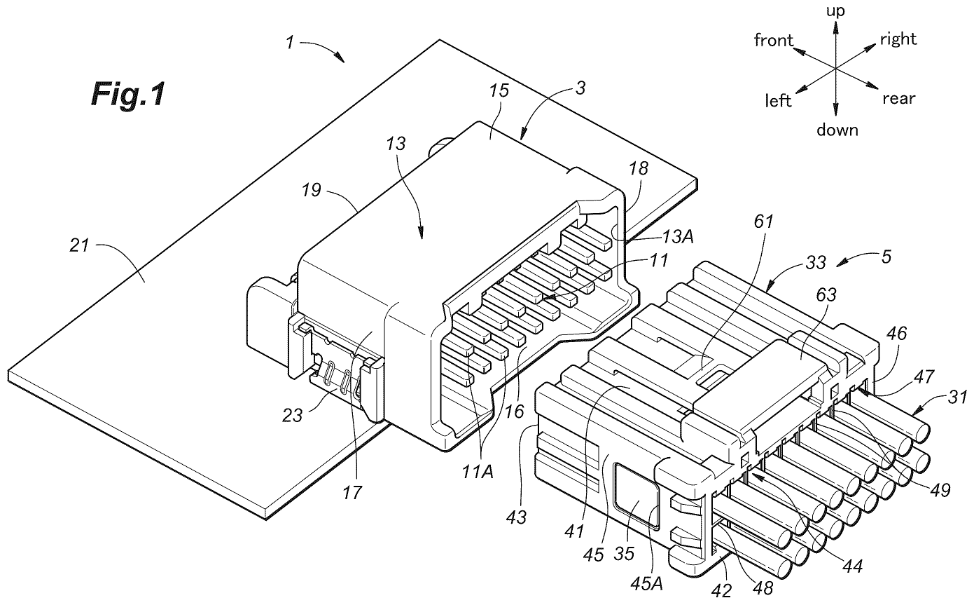

Hereinafter, an electric connector and a pair of electric connectors including the same according to an embodiment of the present invention will be described with reference to the drawings. For convenience of explanation, the up-and-down direction, the front-and-rear direction, and the lateral direction are defined as indicated by arrows in FIG. 1 and the like. However, the arrangement of the electric connector and the pair of electric connectors that are actually used is not limited by these directions.

As shown in FIG. 1, a pair of electric connectors 1 is a device that electrically connects electric wires with each other, or electrically connects an electric wire and a circuit board of an electrical appliance, and the like. The pair of electric connectors 1 includes a male connector 3 and a female connector 5 (an example of an electric connector) that are connectable to each other.

The male connector 3 includes a plurality of male metal terminals 11 (hereinafter referred to as the male terminal(s)), and a male housing 13 made of resin and housing the male terminals 11.

The plurality of male terminals 11 each includes a pin-shaped tip portion 11A, and is arranged at prescribed intervals to be aligned along the lateral direction inside the male housing 13. The plurality of male terminals 11 is arranged in two rows in the up-and-down direction.

The male housing 13 has a box-like shape with a substantially rectangular opening 13A on a rear side thereof. The male housing 13 includes an upper wall 15, a lower wall 16, a left wall 17, a right wall 18, and a front wall 19 that form the outer shell of the male housing 13. The opening 13A is defined by rear edges of the upper wall 15, the lower wall 16, the left wall 17, and the right wall 18. The male housing 13 is fixed to a circuit board 21 by attachment fittings 23 in a state where the lower wall 16 abuts against the circuit board 21. The circuit board 21 is electrically connected to the plurality of male terminals 11. The plurality of male terminals 11 may be respectively connected to an electric wire, instead of to the circuit board 21.

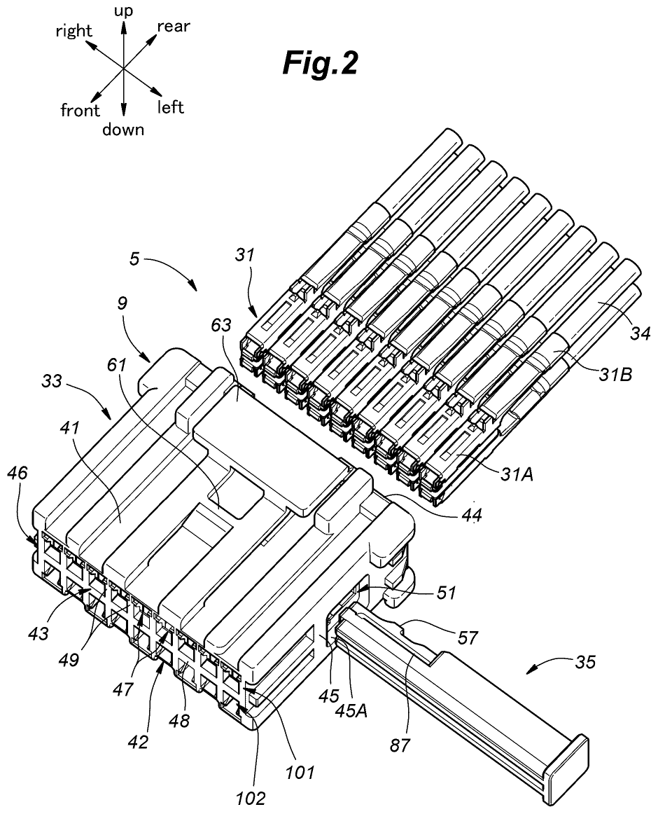

As shown in FIG. 2, the female connector 5 includes a plurality of female metal terminals 31 (hereinafter referred to as the female terminal(s)), a female housing 33 made of resin and housing the female terminals 31, and a retainer 35 made of resin and attached to the female housing 33.

Each female terminal 31 includes a rectangular tubular portion 31A arranged on a front side and a crimping portion 31B arranged on a rear side. An electric wire 34 is connected to the crimping portion 31B. Each female terminal 31 is electrically connectable to the male terminal 11 arranged at the corresponding position in the male connector 3.

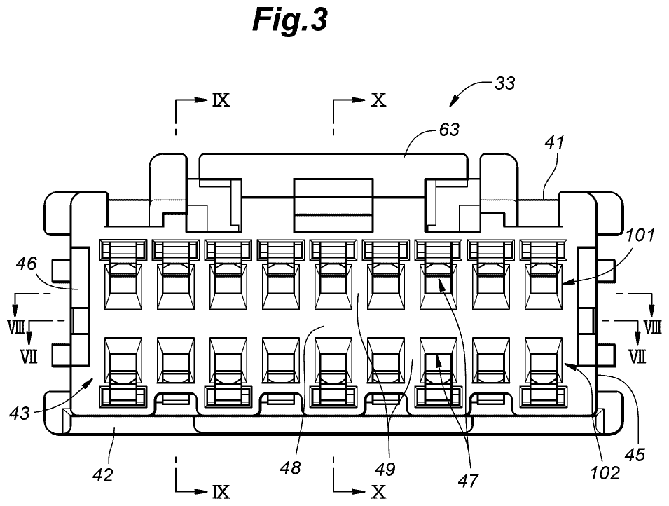

The female housing 33 has a substantially cuboid-like shape, and includes an upper wall 41, a lower wall 42, a front wall 43 (see FIG. 3), a rear wall 44, a left wall 45, and a right wall 46 that form the outer shell of the female housing 33. Further, the female housing 33 includes a partition wall 48 arranged to partition an internal space thereof, and inner walls 49. The partition wall 48 is arranged between the upper wall 41 and the lower wall 42 to be substantially parallel thereto. The female housing 33 includes a complementary structure that is connectable to the male housing 13. The female housing 33 except a portion (i.e., a rear portion) thereof can fit into the male housing 13 as being inserted into the male housing 13 from the opening 13A thereof.

The female housing 33 is provided with a plurality of terminal housing chambers 47 into which the plurality of female terminals 31 is inserted respectively. Each terminal housing chamber 47 has a substantially cuboid-like space, and this space extends in the front-and-rear direction to penetrate the front wall 43 and the rear wall 44. The plurality of terminal housing chambers 47 is aligned along the lateral direction and thereby constitutes each of a first terminal housing chamber group 101 and a second terminal housing chamber group 102. The first terminal housing chamber group 101 and the second terminal housing chamber group 102 are spaced from each other in the up-and-down direction. The first terminal housing chamber group 101 and the second terminal housing chamber group 102 each include the same number of the terminal housing chambers 47, and these terminal housing chambers 47 are arranged so as to overlap with each other in the up-and-down direction.

In the first terminal housing chamber group 101, upper and lower surfaces of each terminal housing chamber 47 are substantially defined by the upper wall 41 and the partition wall 48, respectively. Further, left and right side surfaces of each terminal housing chamber 47 are substantially defined by any one of the plurality of inner walls 49, the left wall 45, and the right wall 46. When viewed in the front-and-rear direction, the inner walls 49 connect the upper wall 41 and the lower wall 42 in the up-and-down direction via the partition wall 48. That is, the upper wall 41 and the partition wall 48 function as an upper wall and a lower wall of the plurality of terminal housing chambers 47 in the first terminal housing chamber group 101, respectively. Moreover, the inner walls 49, the left wall 45, and the right wall 46 each function as sidewalls of the plurality of terminal housing chambers 47 in the first terminal housing chamber group 101.

Similarly, in the second terminal housing chamber group 102, upper and lower surfaces of each terminal housing chamber 47 are substantially defined by the partition wall 48 and the lower wall 42, respectively. Further, left and right side surfaces of each terminal housing chamber 47 are substantially defined by any one of the plurality of inner walls 49, the left wall 45, and the right wall 46. That is, the partition wall 48 and the lower wall 42 function as an upper wall and a lower wall of the plurality of terminal housing chambers 47 in the second terminal housing chamber group 102, respectively. Moreover, the inner walls 49, the left wall 45, and the right wall 46 each function as sidewalls of the plurality of terminal housing chambers 47 in the second terminal housing chamber group 102.

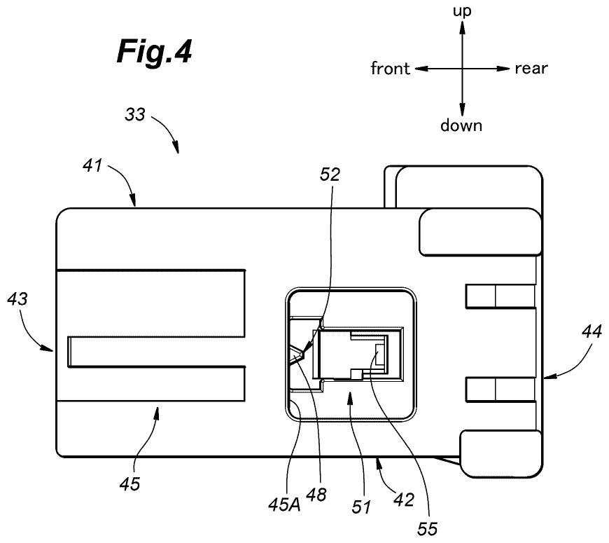

The left wall 45 of the female housing 33 is provided with an opening 45A on an insertion side of a retainer insertion hole 51 into which the retainer 35 is inserted. The retainer insertion hole 51 extends in the lateral direction from the left wall 45 to the right wall 46 inside the female housing 33. The retainer insertion hole 51 is arranged substantially at the center of the female housing 33 in the up-and-down direction. As shown in FIG. 4, the opening 45A formed on the left wall 45 has a substantially rectangular shape with rounded four corners.

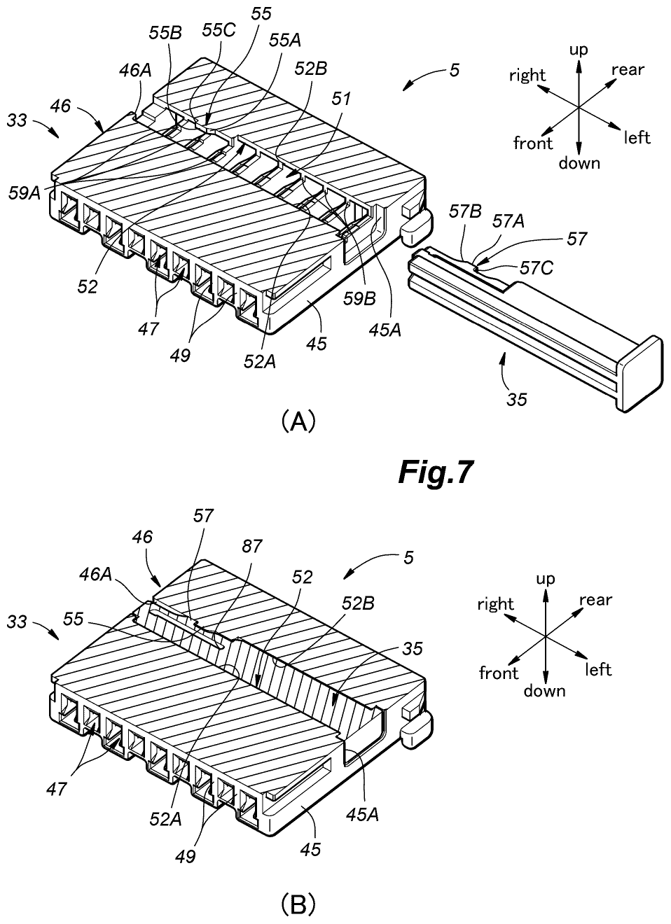

Regarding the retainer insertion hole 51, the partition wall 48 is provided with a retainer opening 52 extending in the lateral direction so as to cut out the center of the partition wall 48 (see (A) and (B) of FIG. 7). The retainer opening 52 is formed to penetrate the left wall 45 and the right wall 46, and defines a portion of the retainer insertion hole 51. Left and right edges of the retainer opening 52 are defined by a front side surface 52A and a rear side surface 52B each extending substantially along the lateral direction. A protrusion 55 (an example of a locking portion; hereinafter referred to as the housing protrusion 55) protruding forward from the rear side surface 52B locks a protrusion 57 (an example of a locked portion; hereinafter referred to as the retainer protrusion 57) formed on the retainer 35.

The housing protrusion 55 includes an inclined surface 55A, a parallel surface 55B, and a vertical surface 55C each having a rectangular shape. A left edge of the inclined surface 55A is connected to the rear side surface 52B, and the inclined surface 55A extends forward and rightward (i.e., diagonally with respect to the rear side surface 52B) from the left edge thereof. The parallel surface 55B is connected to a right edge of the inclined surface 55A, and extends rightward and parallel to the rear side surface 52B. The vertical surface 55C is connected to a right edge of the parallel surface 55B, and extends perpendicularly to the rear side surface 52B. Accordingly, a right edge of the vertical surface 55C is connected to the rear side surface 52B.

In this way, the housing protrusion 55 that locks the retainer protrusion 57 is formed in the retainer opening 52 (more precisely, an edge that defines the opening) provided in the partition wall 48. Accordingly, it is possible to stably secure the strength with which the female housing 33 holds the retainer 35. That is, the force to remove the retainer 35 from the female housing 33 acts along the partition wall 48 (i.e., a virtual plane) having a substantially flat plate shape. Accordingly, it is possible to easily secure the strength to hold the retainer 35 (that is, the strength is unlikely to be affected by the thickness of the wall) as compared with a case where the force acts in a direction perpendicular to the wall. Further, the housing protrusion 55 is formed in the retainer opening 52 of the partition wall 48. Accordingly, it is possible to prevent the formation of the housing protrusion 55 from affecting the thickness of each wall constituting the female housing 33. The housing protrusion 55 may protrude rearward from the front side surface 52A.

The right wall 46 of the female housing 33 is provided with an opening 46A that exposes the tip of the retainer 35 (see (A) and (B) of FIG. 7). However, the opening 46A of the right wall 46 may be omitted. That is, it is not necessary for the retainer insertion hole 51 to penetrate the right wall 46.

As shown in FIG. 1, a locked claw 61 locked by a locking portion provided on an inner surface of the upper wall 15 of the male housing 13 is provided on the upper wall 41 of the female housing 33. The locking portion provided on the inner surface of the upper wall 15 may include an opening or a locking claw that is not shown. Further, the upper wall 41 is provided with an operation piece 63 (see FIG. 1) to be operated by a user. When fitting the female housing 33 into the male housing 13 (i.e., when electrically connecting the female housing 33 to the male housing 13), the user presses the operation piece 63 downward. Accordingly, the user can move an area of the upper wall 41 around the locked claw 61 to an inside (i.e., downward) of the female housing 33. Accordingly, the locked claw 61 is easily locked by the locking portion of the male housing 13.

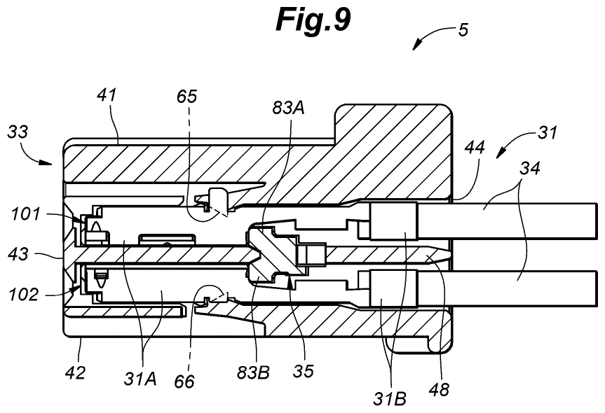

The upper wall 41 of the female housing 33 is provided with a plurality of elastic locking claws 65 (see FIG. 9) at positions corresponding to the plurality of female terminals 31. The plurality of elastic locking claws 65 locks the plurality of female terminals 31 respectively inserted into the plurality of terminal housing chambers 47 constituting the first terminal housing chamber group 101. Accordingly, the plurality of elastic locking claws 65 restricts the rearward movement of the plurality of female terminals 31, respectively. Accordingly, each female terminal 31 is prevented from being removed from the terminal housing chamber 47. Each elastic locking claw 65 is formed into an elastically deformable arm, and can move substantially in the up-and-down direction. When each female terminal 31 is in a regular housing position (in other words, when each female terminal 31 is completely inserted into the terminal housing chamber 47), each elastic locking claw 65 is inserted into an opening formed in a bottom wall of the tubular portion 31A of each female terminal 31. Similarly, the lower wall 42 of the female housing 33 is provided with a plurality of elastic locking claws 66 (see FIG. 9). The plurality of elastic locking claws 66 locks the plurality of female terminals 31 respectively inserted into the plurality of terminal housing chambers 47 constituting the second terminal housing chamber group 102. Accordingly, the plurality of elastic locking claws 66 restricts the rearward movement of the plurality of female terminals 31, respectively. Each elastic locking claw 66 has the same configuration as each elastic locking claw 65. When each female terminal 31 is in the regular housing position, each elastic locking claw 66 is inserted into an opening formed in the bottom wall of the tubular portion 31A of each female terminal 31.

The retainer 35 holds the plurality of female terminals 31 inserted into the terminal housing chambers 47 of the female housing 33. More specifically, in a state where the retainer 35 is inserted into the retainer insertion hole 51 of the female housing 33, the retainer 35 engages with each female terminal 31 in the regular housing position. Accordingly, the retainer 35 restricts the rearward movement of each female terminal 31. The retainer 35 can restrict the rearward movement of all the female terminals 31 inserted into the first terminal housing chamber group 101 and the second terminal housing chamber group 102, respectively. Accordingly, the rearward movement of each female terminal 31 is doubly restricted by the elastic locking claws 65 and 66 of the female housing 33 and the retainer 35.

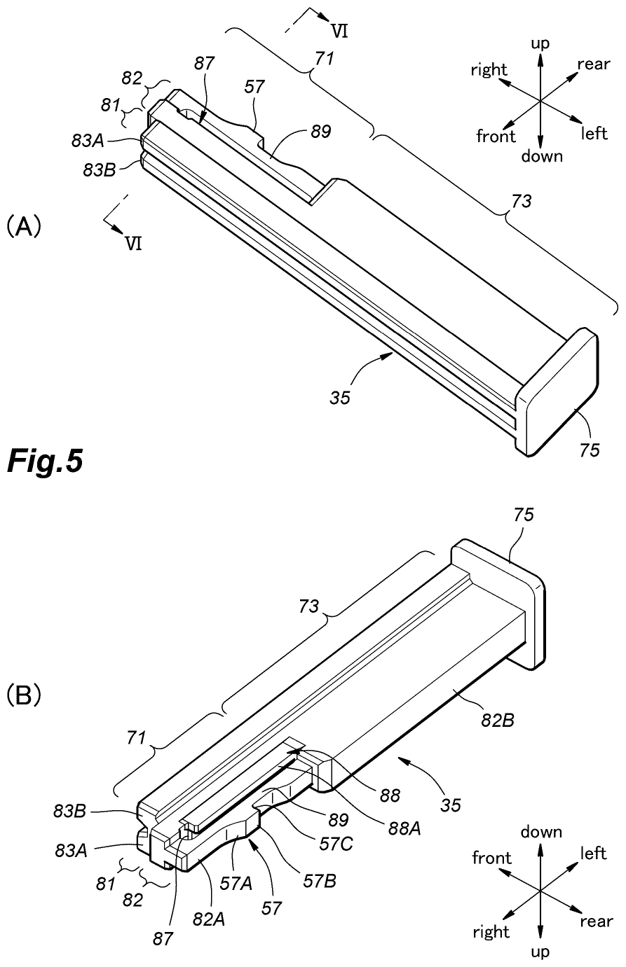

As shown in (A) and (B) of FIG. 5, with respect to the lateral direction, the retainer 35 can be divided into an insertion side portion 71 arranged on an insertion side to the female housing 33, a base portion 73 arranged to the left of the insertion side portion 71, and a flange portion 75 formed at a left end of the base portion 73.

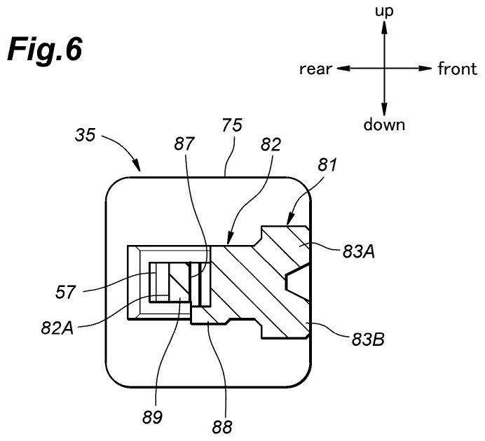

Furthermore, with respect to the front-and-rear direction, the retainer 35 can be divided into a front portion 81 and a rear portion 82. As shown in FIG. 6, the rear portion 82 in the insertion side portion 71 forms a projection projecting rearward in a cross section perpendicular to the lateral direction. That is, a rear side of the rear portion 82 in the insertion side portion 71 (i.e., a tip side of the projection) has a narrower up-and-down dimension than a front side thereof. The rear portion 82 in the insertion side portion 71 has a rear surface 82A extending substantially along the lateral direction so as to be perpendicular to the front-and-rear direction. The retainer 35 is provided with the retainer protrusion 57 that protrudes rearward from the rear surface 82A. The retainer protrusion 57 is locked by the housing protrusion 55. The retainer protrusion 57 has an inclined surface 57A, a parallel surface 57B, and a vertical surface 57C each having a rectangular shape. A right edge of the inclined surface 57A is connected to the rear surface 82A, and the inclined surface 57A extends rearward and leftward (i.e., diagonally with respect to the rear surface 82A) from the right edge thereof. The parallel surface 57B is connected to a left edge (i.e., a rear portion in the insertion direction) of the inclined surface 57A, and extends leftward to be parallel to the rear surface 82A. The vertical surface 57C is connected to a left edge of the parallel surface 57B, and extends perpendicularly to the rear surface 82A. Accordingly, a left edge of the vertical surface 57C is connected to the rear surface 82A.

Further, the insertion side portion 71 is provided with a long hole 87 inside the retainer protrusion 57 (i.e., in front of the retainer protrusion 57). The long hole 87 penetrates the rear side (i.e., a narrow portion) of the rear portion 82 in the up-and-down direction. Accordingly, a portion between the retainer protrusion 57 and the long hole 87 functions as an elastic deformation portion 89 that is elastically deformed when the retainer protrusion 57 is locked by the housing protrusion 55. As shown in FIG. 6, the elastic deformation portion 89 is provided on the rear side of the rear portion 82 forming the projection. Accordingly, the up-and-down dimension of the elastic deformation portion 89 is smaller than the maximum value of the up-and-down dimension of the whole of the rear portion 82 in the insertion side portion 71. Accordingly, it is possible to prevent the deformation of the elastic deformation portion 89 between the retainer protrusion 57 and the long hole 87 from being inhibited (in other words, to prevent the user from being required to use an excessive operation force) while securing the rigidity of the insertion side portion 71 as much as possible.

In the rear portion 82 in the insertion side portion 71, a cover piece 88 is provided below the long hole 87 to cover the long hole 87 (see (B) of FIG. 5). A rear edge 88A of the cover piece 88 is arranged more forward than the rear surface 82A of the rear portion 82. In a state where the retainer 35 is inserted into the female housing 33, the rear edge 88A of the cover piece 88 abuts against a portion of each inner wall 49 (i.e., a notch 59A of each inner wall 49 that defines the retainer insertion hole 51 (see (A) of FIG. 7)). Accordingly, the retainer 35 can more stably prevent the female terminals 31 from being removed from the female housing 33. Further, one opening of the long hole 87 is covered with the cover piece 88. Accordingly, it is possible to prevent unintended electrical connection (i.e., a short circuit) in the penetration direction of the long hole 87 from occurring between a female terminal 31 arranged near the long hole 87 and inserted into the terminal housing chamber 47 in the first terminal housing chamber group 101 and another female terminal 31 arranged near the long hole 87 and inserted into the terminal housing chamber 47 in the second terminal housing chamber group 102. In the retainer 35, the cover piece 88 may be provided above the long hole 87 (or above and below the long hole 87).

When viewed in the lateral direction of the retainer 35 (see FIG. 6), the front portion 81 in the insertion side portion 71 includes a first terminal locking portion 83A protruding upward and forward from the rear portion 82, and a second terminal locking portion 83B protruding downward and forward from the rear portion 82 on a side of the terminal housing chambers 47. The first terminal locking portion 83A locks the plurality of female terminals 31 respectively inserted into the plurality of terminal housing chambers 47 that constitutes the first terminal housing chamber group 101. Accordingly, the first terminal locking portion 83A restricts the rearward movement of the plurality of female terminals 31, respectively. The second terminal locking portion 83B locks the plurality of female terminals 31 respectively inserted into the plurality of terminal housing chambers 47 that constitutes the second terminal housing chamber group 102. Accordingly, the second terminal locking portion 83B restricts the rearward movement of the plurality of female terminals 31, respectively.

The front portion 81 in the base portion 73 has a shape similar to that of the front portion 81 in the insertion side portion 71 (that is, the front portion 81 has a uniform shape from the insertion side portion 71 to the base portion 73). The front portion 81 includes the first terminal locking portion 83A and the second terminal locking portion 83B.

The rear portion 82 in the base portion 73 is arranged to the left (i.e., to the rear in the insertion direction) of the rear portion 82 in the insertion side portion 71. A rear surface 82B (see (B) of FIG. 5) of the rear portion 82 in the base portion 73 extends along the lateral direction to be perpendicular to the front-and-rear direction, and is arranged more rearward than the rear surface 82A of the rear portion 82 in the insertion side portion 71. Further, the rear portion 82 in the base portion 73 has a substantially cuboid-like shape.

In a plan view, the insertion side portion 71 including the retainer protrusion 57 has a smaller front-and-rear dimension than the base portion 73. Accordingly, even if the retainer protrusion 57 is provided as the locked portion of the retainer 35 that is locked by the female housing 33, it is possible for the base portion 73 to secure the front-and-rear dimension required for the female housing 33 to stably hold the retainer 35 while suppressing an increase in the front-and-rear dimension. However, in a plan view, the front-and-rear dimension of the insertion side portion 71 including the retainer protrusion 57 may be set larger than the front-and-rear dimension of the base portion 73, if necessary.

The flange portion 75 can be fitted into the opening 45A of the female housing 33, and the outer edge of the flange portion 75 has a substantially rectangular shape with rounded four corners.

Next, an operation by the user for mounting the retainer 35 on the female housing 33 (i.e., an operation for locking the plurality of female terminals 31 by the retainer 35) will be described.

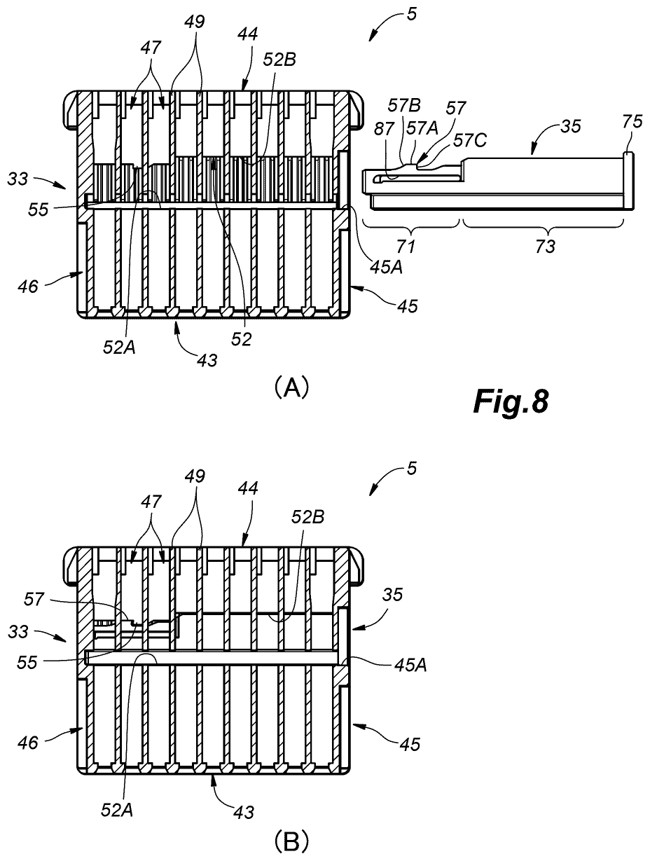

In a state shown in (A) of FIG. 7 and (A) of FIG. 8, the user (not shown) inserts the retainer 35 into the retainer insertion hole 51 by moving the retainer 35 rightward. Accordingly, the retainer 35 is mounted on the retainer insertion hole 51, as shown in (B) of FIG. 7 and (B) of FIG. 8.

During the insertion of the retainer 35 into the retainer insertion hole 51, the inclined surface 57A of the retainer protrusion 57 abuts against the inclined surface 55A of the housing protrusion 55. In this state, the user further pushes the retainer 35 rightward. Accordingly, the retainer protrusion 57 moves to the right of the housing protrusion 55 to get over the housing protrusion 55 while moving inward (i.e., forward). Accordingly, the vertical surface 57C of the retainer protrusion 57 abuts against the vertical surface 55C of the housing protrusion 55, and the leftward movement of the retainer 35 is restricted. Accordingly, the retainer 35 is prevented from being removed from the retainer insertion hole 51.

As shown in (B) of FIG. 7, in a portion (i.e., a portion arranged on a right side) corresponding to the insertion side portion 71 of the retainer 35, the front-and-rear dimension of the retainer opening 52 (that is, the distance between the front side surface 52A and the rear side surface 52B except the housing protrusion 55) defining the retainer insertion hole 51 is substantially the same as the front-and-rear dimension of the insertion side portion 71 of the retainer 35 including the retainer protrusion 57, or is slightly larger than the front-and-rear dimension of the insertion side portion 71. Further, in a portion corresponding to the base portion 73 of the retainer 35 (i.e., a portion arranged in the center and on a left side), the front-and-rear dimension of the retainer opening 52 is larger than the front-and-rear dimension of the portion corresponding to the insertion side portion 71, or equal to the front-and-rear dimension of the portion corresponding to the insertion side portion 71. Accordingly, until the inclined surface 57A of the retainer protrusion 57 abuts against the inclined surface 55A of the housing protrusion 55, the insertion of the retainer 35 into the retainer insertion hole 51 is not inhibited.

Further, as shown in (A) of FIG. 7, in a portion corresponding to the retainer insertion hole 51, each inner wall 49 of the female housing 33 is provided with a notch 59A or 59B formed to correspond to the cross-sectional shape of the retainer 35. The notch 59A of the inner wall 49 defining a portion of the retainer insertion hole 51 corresponding to the insertion side portion 71 of the retainer 35 has a smaller front-and-rear dimension than the notch 59B of the inner wall 49 defining a portion of the retainer insertion hole 51 corresponding to the base portion 73. Accordingly, the inner walls 49 provided with the notches 59A and 59B having different front-and-rear dimensions are arranged to correspond to the insertion side portion 71 and the base portion 73 of the retainer 35, respectively. Accordingly, it is possible to stably hold each of the insertion side portion 71 of the retainer 35 with a smaller front-and-rear dimension and the base portion 73 of the retainer 35 with a larger front-and-rear dimension.

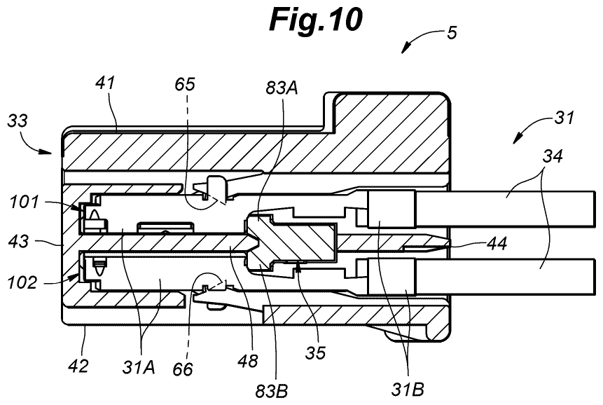

When the attachment of the retainer 35 to the female housing 33 is completed, as shown in FIGS. 9 and 10, the first terminal locking portion 83A of the retainer 35 abuts against a rear end of the tubular portion 31A of the female terminal 31 inserted into the terminal housing chamber 47 that constitutes the first terminal housing chamber group 101. Accordingly, the female terminal 31 is prevented from moving rearward (i.e., the female terminal 31 is prevented from being removed from the terminal housing chamber 47). Similarly, the second terminal locking portion 83B of the retainer 35 abuts against a rear end of the tubular portion 31A of the female terminal 31 inserted into the terminal housing chamber 47 that constitutes the second terminal housing chamber group 102. Accordingly, the female terminal 31 is prevented from moving rearward.

In the foregoing, the present invention has been described based on specific embodiments. However, these embodiments are merely examples, and the present invention is not limited by these embodiments. Not all of the components of the electric connector and the pair of electric connectors shown in the above embodiments are indispensable, and at least those skilled in the art can select the components as appropriate without deviating from the scope of the present invention.

### GLOSSARY OF TERMS

1: pair of electric connectors
3: male connector (an example of another electric connector)
5: female connector (an example of an electric connector)
11: male terminal
13: male housing
15: upper wall
16: lower wall
17: left wall
18: right wall
19: front wall
21: circuit board
23: attachment fitting
31: female terminal (an example of a metal terminal)
33: female housing
34: electric wire
35: retainer
41: upper wall
42: lower wall
43: front wall
44: rear wall
45: left wall
46: right wall
46A: opening
47: terminal housing chamber
48: partition wall
49: inner wall
51: retainer insertion hole
52: retainer opening
52A: front side surface
52B: rear side surface
55: housing protrusion (an example of a locking portion)
57: retainer protrusion (an example of a locked portion)
59A, 59B: notch
61: locked claw
63: operation piece
65: elastic locking claw
71: insertion side portion
73: base portion
75: flange portion
81: front portion
82: rear portion
83A: first terminal locking portion
83B: second terminal locking portion
85: locking protrusion
87: long hole
88: cover piece
89: elastic deformation portion
101: first terminal housing chamber group
102: second terminal housing chamber group

1. An electric connector, comprising:
a plurality of metal terminals;
a housing provided with a plurality of terminal housing chambers into which the plurality of metal terminals is inserted respectively, and a retainer insertion hole extending in a lateral direction perpendicular to a front-and-rear direction that corresponds to an insertion direction of the plurality of metal terminals; and
a retainer inserted into the retainer insertion hole and thereby holding the plurality of metal terminals inserted into the plurality of terminal housing chambers,
wherein the plurality of terminal housing chambers is aligned along the lateral direction and thereby constituting each of a first terminal housing chamber group and a second terminal housing chamber group,
the first terminal housing chamber group and the second terminal housing chamber group are spaced from each other in an up-and-down direction that is perpendicular to each of the front-and-rear direction and the lateral direction,
the housing includes a partition wall arranged between the first terminal housing chamber group and the second terminal housing chamber group,
the partition wall is provided with a retainer opening that defines a portion of the retainer insertion hole,
the retainer includes a locked portion locked by the housing in a state where the retainer is inserted into the retainer insertion hole, and
a locking portion configured to lock the locked portion of the retainer is formed in the retainer opening.

2. The electric connector according to claim 1, wherein the locked portion of the retainer is a protrusion that protrudes to a front or rear of the retainer,
the retainer includes an insertion side portion provided with the protrusion, and a base portion formed continuously with the insertion side portion, and
a front-and-rear dimension of the insertion side portion including the protrusion is equal to or less than a front-and-rear dimension of the base portion.

3. The electric connector according to claim 2, wherein the housing includes an upper wall and a lower wall that form an outer shell thereof,
the housing includes a plurality of inner walls arranged at a prescribed interval in the lateral direction, and each of the plurality of inner walls connects the upper wall and the lower wall in the up-and-down direction via the partition wall,
the plurality of inner walls defines left and right sidewalls of each of the plurality of terminal housing chambers, and each of the plurality of inner walls is provided with a notch defining a portion of the retainer insertion hole, and
the notch of an inner wall among the plurality of inner walls corresponding to the insertion side portion of the retainer has a smaller front-and-rear dimension than the notch of another inner wall among the plurality of inner walls corresponding to the base portion of the retainer.

4. The electric connector according to claim 2, wherein the insertion side portion of the retainer is provided with a long hole arranged inside the protrusion and penetrating through the insertion side portion in the up-and-down direction.

5. The electric connector according to claim 4, wherein the retainer includes a cover piece arranged to cover at least one opening of the long hole in a penetration direction thereof.

6. The electric connector according to claim 4, wherein an elastic deformation portion configured to deform elastically when the protrusion is locked by the locking portion is formed between the protrusion and the long hole of the retainer, and
an up-and-down dimension of the elastic deformation portion is smaller than a maximum value of an up-and-down dimension of a whole of the insertion side portion.

7. The electric connector according to claim 1, wherein at least one of the plurality of metal terminals is a female metal terminal that is connectable to a male metal terminal, and
the housing is a female housing that is connectable to a male housing that holds the male metal terminal.

8. A pair of electric connectors, comprising:
the electric connector according to claim 1; and
another electric connector that is connectable to the electric connector.
